(19) United States
(12) Patent Application Publication
(10) Pub. No.: US 2025/0200172 A1
(43) Pub. Date: Jun. 19, 2025

(54) SYSTEMS AND METHODS FOR DETECTING SPOOFING ATTACKS ON AN UNMANNED AERIAL SYSTEM

(71) Applicants: Intelligent Fusion Technology, Inc., Germantown, MD (US); The Research Foundation for The State University of New York, Albany, NY (US)

(72) Inventors: Sixiao WEI, Germantown, MD (US); Ronghua XU, Binghamton, NY (US); Yu CHEN, Binghamton, NY (US); Erik BLASCH, Arlington, VA (US); Khanh PHAM, Kirtland AFB, NM (US); Genshe CHEN, Germantown, MD (US)

(21) Appl. No.: 18/541,893

(22) Filed: Dec. 15, 2023

(51) Int. Cl. H04W 12/121; H04W 12/02

(52) U.S. Cl. CPC G06F 21/55; G05D 1/226

(57) ABSTRACT

A method for detecting spoofing attacks on a UAV includes receiving signals from the UAV that is an edge device of a decentralized network, transmitting the signals to a fog node of the decentralized network, and detecting the spoofing attacks by detecting slow shifting patterns and running a trained attack detection model at the fog node for the signals. The decentralized network is based on an edge-fog-cloud computing paradigm.

### GOVERNMENT RIGHTS

This invention was made with Government support under Contract No. FA955022P0011, awarded by the Air Force Office of Scientific Research (AFOSR) of the United States Department of Defense. The U.S. Government has certain rights in the present disclosure.

### TECHNICAL FIELD

The present disclosure generally relates to the field of blockchain fabric and, more particularly, relates to lightweight blockchain fabric for urban air mobility (UAM) networks. The present disclosure also relates to the field of spoofing attack detection and, more particularly, relates to the detection of global positioning system (GPS) spoofing attacks on unmanned aerial vehicles (UAVs).

### BACKGROUND

A UAM network encompasses air traffic operations for manned and unmanned aircraft systems in a metropolitan area. The UAM network can help ease traffic congestion and offer fast and efficient transport with a more integrated transportation system, especially for densely populated areas. With the ever-increasing presence of unmanned aerial systems (UAS) such as unmanned aerial vehicles (UAVs) in UAM networks, concerns about performance, security, and privacy are rising. At the architectural level, conventional applications rely on a centralized framework, which is prone to a single point of failure. As centralized servers coordinate flying UAVs and perform decision-making tasks, the entire UAV system can be paralyzed if the control centers experience malfunctions or are under attacks. In addition, centralized frameworks that swarm a large number of distributed UAVs are prone to performance bottlenecks. Furthermore, when a UAV is compromised at a single point, the effects can propagate across the entire UAM network and lead to catastrophic outcomes.

Further, with technological advancements, UAS such as UAVs have found various civilian and commercial applications, such as aerial surveillance, cargo transportation, search and rescue, pollution monitoring, agriculture, photography, and film-making. Typically, UAVs are classified into two categories based on the wing type, i.e., fixed-wing UAVs and multirotor UAVs. With the characteristics of hovering at a location in the air and flexibly changing flight directions, multirotor UAVs have become increasingly used in various applications. Unlike a traditional aircraft, which flies mostly over regions with a sparse population, many operations of UAVs occur over metropolitan areas that are highly dense in population and property. Thus, there is an increase in burdens on avionics to support public safety and security due to the increase in UAV activities. For example, recent events have shown that certain UAVs are vulnerable to attacks and subversions through buggy or sometimes malicious devices. In particular, signals of a global positioning system (GPS) at a UAV can be attacked and become compromised, severely affecting the control and performance of the UAV and posing risks of disrupting the UAM network.

The disclosed systems and methods are directed to solve one or more problems set forth above and other problems.

### BRIEF SUMMARY OF THE DISCLOSURE

In one aspect of the present disclosure, a method for detecting spoofing attacks on a UAV includes receiving signals from the UAV that is an edge device of a decentralized network, transmitting the signals to a fog node of the decentralized network, and detecting the spoofing attacks by detecting slow shifting patterns and running a trained attack detection model at the fog node for the signals. The decentralized network is based on an edge-fog-cloud computing paradigm.

In another aspect of the present disclosure, a method for forming a lightweight blockchain fabric includes providing a UAM network, providing a lightweight blockchain module, providing a machine learning (ML)-based anomaly detection module, and forming the lightweight blockchain fabric that includes the UAM network, the lightweight blockchain module, and the ML-based anomaly detection module. The UAM network provides on-demand automated transportation services. The lightweight blockchain module includes a first sub-system and a second sub-system. The first sub-system includes a lightweight consensus protocol that relies on a randomly selected consensus committee to achieve a low latency when committing transactions on a distributed ledger. The second sub-system includes a hybrid on-chain and off-chain storage that improves efficiency and privacy-preservation. The ML-based anomaly detection module includes one or more trained ML-based attack detection models.

In another aspect of the present disclosure, a method for forming a lightweight blockchain includes providing a first sub-system, providing a second sub-system, and forming the lightweight blockchain that includes the first and second sub-systems. The first sub-system includes a lightweight consensus protocol that relies on a randomly selected consensus committee to achieve a low latency when committing transactions on a distributed ledger. The second sub-system includes a hybrid on-chain and off-chain storage that improves efficiency and privacy-preservation. The hybrid on-chain and off-chain storage includes distributed data storage (DDS) built on a swarm network. The DDS is arranged to save UAV data and flight logs. The UAV data and flight logs are accessible by a swarm hash.

Other aspects or embodiments of the present disclosure can be understood by those skilled in the art in light of the description, the claims, and the drawings of the present disclosure.

### BRIEF DESCRIPTION OF THE DRAWINGS

The following drawings are examples for illustrative purposes according to various disclosed embodiments and are not intended to limit the scope of the present disclosure.

FIG. 1 is a diagram illustrating a lightweight blockchain fabric for a UAM network in accordance with various embodiments of the present disclosure;

FIG. 2 is a diagram illustrating a lightweight blockchain workflow in accordance with various embodiments of the present disclosure;

FIG. 3 is a diagram illustrating an exemplary UAM network environment in accordance with various embodiments of the present disclosure;

FIG. 4 is a diagram illustrating an exemplary UAV structure in accordance with various embodiments of the present disclosure;

FIG. 5 illustrates an exemplary method for detecting spoofing attacks in accordance with various embodiments of the present disclosure;

FIG. 6 illustrates an exemplary method for forming a lightweight blockchain fabric in accordance with various embodiments of the present disclosure; and

FIG. 7 illustrates an exemplary method for forming a lightweight blockchain in accordance with various embodiments of the present disclosure.

### DETAILED DESCRIPTION

Reference will now be made in detail to exemplary embodiments of the disclosure, which are illustrated in the accompanying drawings.

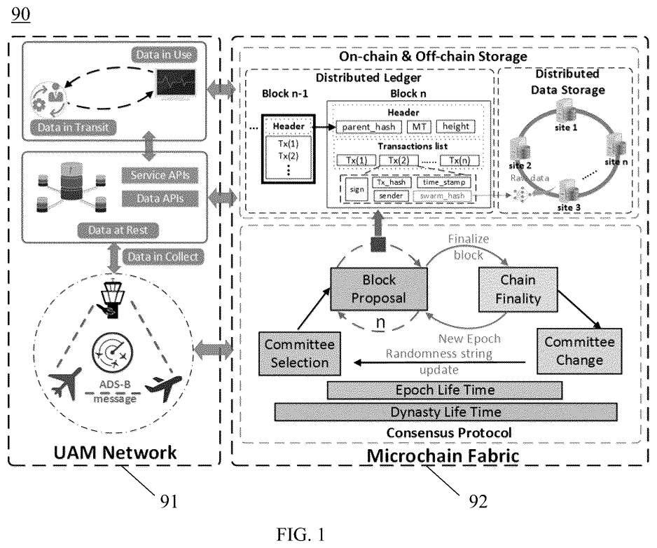

FIG. 1 is a schematic diagram illustrating a lightweight blockchain fabric 90 for a UAM network 91 in accordance with the present disclosure. The lightweight blockchain fabric includes the UAM network 91, a lightweight blockchain module 92, and a ML-based anomaly detection module (not shown). The lightweight blockchain module 92 may also be referred to as a microchain fabric 92. The ML-based anomaly detection module contains one or more trained ML-based attack detection models. In descriptions below, UAVs are used to represent UAS exemplarily.

The UAM network 91 provides on-demand automated transportation services. Each UAV uses its onboard sensors to enroll and capture raw mission data, such as automatic dependent surveillance-broadcast (ADS-B) messages or micro air vehicle link (MAVLink) messages, and these data may be digitized and converted to key features, such as aircraft identification and trajectories. The operation centers (e.g., ground stations) may collect data for flight planning and monitoring. In addition, raw data may be transferred to an avionic data center that provides long-term storage services (e.g., data at rest) for high-level information fusion and analysis. Further, a cloud server performs high-level computing extensive and big-data-oriented tasks such as multi-airborne collaborative planning and decision-making reasoning. Based on a thorough analysis of shared avionics data, intelligent avionic services (e.g., data in transit) incorporate AI technologies to optimize UAV services and protect against never-before-seen attacks. Information visualization (e.g., data in use) provides context-based human-machine interactions for authorized users to learn dynamic mission priorities and resource availability.

The lightweight blockchain module 92 (or the microchain fabric 92) acts as a security and trust networking infrastructure to provide decentralized security and privacy-preserving guarantees for UAM data. The lightweight blockchain leverages a permissioned network management and assumes that the system administrator is a trustworthy oracle to maintain the registered identity profiles of UAM. Thus, each UAV or user uses their unique ID to identify authentication and access control procedures. In addition, cryptographic primitives such as public key infrastructure (PKI) and encryption algorithms may guarantee the confidentiality and integrity of UAV data (e.g., ADS-B) in communication. Moreover, the lightweight blockchain integrates a lightweight consensus protocol with a hybrid on-chain and off-chain storage to ensure UAV data and flight logs are stored securely and distributively without relying on any centralized server.

As shown in FIG. 1, the lightweight blockchain module 92 contains a first sub-system and a second sub-system. The first sub-system is a lightweight consensus protocol that relies on a randomly selected consensus committee to achieve a low latency when committing transactions on the distributed ledger. The second sub-system is a hybrid on-chain and off-chain storage that consists of both on-chain and off-chain storage mechanisms. The on-chain storage and off-chain storage may work closely with a hand-in-hand manner. As such, efficiency and privacy-preservation may be improved.

Certain core functionalities and workflows are briefly described as follows.

The lifetime of a committee is defined as a dynasty. All nodes within a network use a random committee election mechanism to construct a new committee at the beginning of a new dynasty. New committee members rely on their neighboring peers, which use a node discovery protocol to reach out to each other. Further, all committee members maintain a fully connected consensus network and non-committee nodes periodically synchronize states of the current dynasty. Until the current dynasty's lifetime ends, committee members utilize an epoch randomness generation protocol to cooperatively propose a global random seed for the next committee election.

Given a synchronous network environment, operations of consensus processes are coordinated in sequential rounds called epochs. The block proposal leverages an efficient proof-of-credit (PoC) algorithm, which allows the consensus committee to continuously publish blocks containing transactions and extend the main chain length. The block proposal process continues running multiple rounds until the end of an epoch. Then, a voting-based chain finality protocol allows committee members to make an agreement on a checkpointing block. As a result, temporary fork chains are pruned, and these committed blocks are finalized on the unique main chain.

Referring to FIG. 1, the upper right part illustrates the second sub-system, i.e., the hybrid on-chain and off-chain storage. An exemplary organization of the hybrid on-chain and off-chain storage is depicted in the figure. As the basic unit of on-chain data recorded on the distributed ledger, a block contains header information (e.g., previous block hash and block height) and orderly transactions. The DDS, which is built on a swarm network, is used as the off-chain storage. The UAV data and flight logs that require heterogeneous formats and various sizes are saved on the DDS, and they may be easily addressed by their swarm hash. In an optimal manner, each transaction only contains a swarm hash as a reference pointing to its raw data on the DDS. Compared with raw data, a swarm hash has a small and fixed length (e.g., 32 or 64 bytes). Therefore, all transactions may have almost the same data size. It may improve efficiency in transaction propagation without directly padding raw data into transactions.

The goal of the lightweight blockchain is to enable a lightweight distributed ledger system in resource-constrained environments at the network edge, which is achieved by introducing an efficient consensus mechanism running on a small number of validators that serve on the committee. Considering the resource constraints, the entire network may be constructed following a hierarchical architecture such that the committee size is small (i.e., 32 is recommended and not larger than 64 for decent throughput). The lightweight blockchain network processes transactions by a final committee in fixed time periods called dynasty epochs. A random committee formation protocol ensures that the committee selection process is unpredictable. In each dynasty lifetime, a hybrid consensus mechanism is responsible for proposing block and finalizing chain history given an unbounded time delay. The final-committee consensus is built on a proof-of-stake based finality mechanism. A Proof-of-Credit (PoC) protocol determines whether a participant is selected to propose a block given fair initial distribution of the credit stake to the committee members in a given epoch. A Voting based Chain Finality (VCF) mechanism could protect against a fork by resolving conflicting checkpoints and finalize the history of a blockchain.

The lightweight blockchain assumes a synchronous network in which operations of processes are coordinated in rounds with bounded delay constraints, and provides two formal proprieties of a robust distributed ledger: (1) Persistence: ensures a safety goal that all users should agree on so that the same transactions and finalized transactions are in the same position in the distributed ledger. If an honest node of the system accepts a transaction Tₓ as finalized in block Bᵢ, other nodes could query Tₓ in block Bᵢ. (2) Liveness: ensures transactions submitted by honest nodes are confirmed in finalized blocks after a sufficient amount of time.

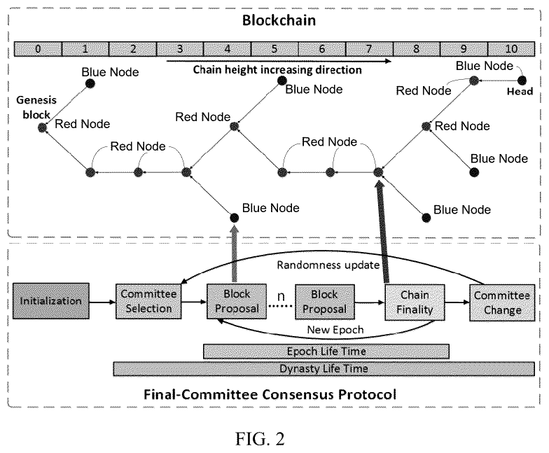

FIG. 2 is a diagram illustrating a lightweight blockchain workflow in accordance with the present disclosure. The lightweight blockchain is developed and used in a decentralized environment (e.g., an edge-fog-cloud computing paradigm) to guarantee security and privacy requirements in UAV data access and sharing scenarios. An exemplary structure of the lightweight blockchain is illustrated in the upper part of FIG. 2. The blue nodes represent confirmed blocks, while the red nodes indicate finalized blocks. The genesis block is the root node of the blockchain, and each block uses its pre_hash to point to its parent block and extend chain. The chain height follows a strictly increasing sequence of finalized blocks (e.g., path through red nodes). The head of the blockchain is the last confirmed block whose parent is finalized and has the largest height. The lower part of FIG. 2 illustrates certain key components in the lightweight blockchain network. The workflow are described as follows:

At the initialization step, a special dynasty, which includes a group of validators specified by an administer, acts as an initial committee Dᵢₙᵢₜ to initialize the blockchain. It creates genesis block B₀ and sets the local blockchain C=B₀ and head=B₀. The initial committee may work as the first dynasty of the system until the following dynasty change is finished. Thus, B₀ is the beginning block of an initial dynasty epoch.

At the committee selection step, if the current dynasty is the initial committee, this step is skipped. Otherwise, at the beginning of a new dynasty lifetime, the final committee formation protocol exploits a Verifiable Random Function (VRF) based cryptographic sortition scheme to randomly choose a subset of validators V as the final committee according to their credit weight. The selected committee members D will be added to the current block, which is marked as the beginning block of a new dynasty epoch. The lifetime of a dynasty epoch starts from the committee selection step and ends after dynasty change.

At the block proposal step, the block proposal mechanism uses a protocol, called Proof-of-Credit (PoC), to generate new blocks in each block proposal run. Only validators in the current dynasty can propose new blocks. The probability that a user could propose a block is associated with the credit distribution of the current dynasty. If validator vⱼ could solve the puzzle difficulty problem in slot Sₜ₊₁ by computing H(B₀, pkⱼ, cⱼ)≤d_{cond} (d_{cond} is difficulty condition target value), it generates a new block Bᵢ₊₁=(H(Bᵢ), height+1, tx_data, Tₛₜₐₘₚ, pkⱼ, σⱼ) and broadcasts it with a valid signature to all committee members of the current dynasty. Each committee member accepts all valid blocks in the current slot, and verifies if blocks meet confirmation requirements. The verified block will be added to local chain C with head=Bᵢ₊₁.

Referring to the chain finality step. At the end of an epoch, the head with epoch height becomes a checkpoint which is used to resolve forks and finalize chain history. The chain finality uses a voting-based algorithm to commit a checkpoint block and finalizes the already committed blocks on the main chain. The chain finality ensures that only one path including finalized blocks becomes the main chain, as FIG. 2 shows. Therefore, the following blocks in a new epoch are only extended on such a unique main chain. The chain fork problem is prevented by resolving conflicting checkpoints and finalizing the history of the blockchain.

Referring to the committee change step. At the end of a dynasty lifetime, the current committee members make an agreement on a new dynasty randomness string. The epoch randomness string generation uses the RandShare mechanism to make an agreement on proposing the next epoch randomness string among members of the final committee. RandShare is a randomness protocol that is based on Publicly Verifiable Secret Sharing (PVSS) to ensure unbiasability, unpredictability, and availability in public randomness sharing. The unbiasable and unpredictable public randomness string may be used for the committee selection process of the next dynasty lifetime.

The shift from centralized UAM networks to decentralized blockchain-assisted UAM systems improves the efficiency of system operations and ensures security and privacy guarantees. Existing blockchain-based UAM solutions mainly consider blockchain as a trusted network and immutable storage to improve the efficiency of communications, incentive mechanisms, security of access authentication, and data sharing processes. However, directly adopting conventional blockchains to build decentralized UAM networks still meets tremendous challenges in some cases such as internet of drones (IoD) scenarios. The current solutions based on permissionless blockchains (e.g., Bitcoin or Ethereum) demand high computation resources in proof-of-work (PoW) mining processes such that they are not affordable to resource-constrained drones (i.e., UAVs). While using permissionless blockchains such as Hyperledger can achieve low energy consumption and high throughout, they are highly limited in terms of scalability and communication complexity.

To address the aforementioned limitations of integrating blockchain into UAM networks, the present disclosure provides a lightweight blockchain fabric for data assurance and operation resilience-oriented UAM networks. Unlike existing works that rely on computation-intensive PoW blockchains, the lightweight blockchain fabric (e.g., the lightweight blockchain fabric 90 shown in FIG. 1) adopts a lightweight-designed blockchain to achieve efficiency and security guarantees for a small-scale permissioned UAM network. As UAV information and flight logs are securely and accurately stored on the immutable distributed ledger of the lightweight blockchain, participants within a UAM network may verify the authenticity of UAVs and verify tamper-proof data sent to/from UAVs without relying on a third-party agency. Compared with blockchain-based UAM networks that either directly save raw data on the distributed ledger or outsource raw data to a cloud server, the lightweight blockchain fabric allows encrypted data to be stored on a DDS, while the lightweight blockchain only records references of data as checkpoints. Such a hybrid on-chain and off-chain storage not only improves performance (e.g., latency and throughput) but also ensures privacy preservation for sensitive information in UAM networks.

Further, the lightweight blockchain leverages a proof-of-credit (PoC) voting-based chain finality (VCF) consensus protocol to reduce computation and communication overheads on Internet of Things (IoT) systems. Blockchain performance (e.g., network latency, transaction throughput, and computation overheads) may be evaluated by using a lightweight blockchain-enabled security mechanism to access authentication and data-sharing process scenarios.

In terms of the optimization for UAV data storage, a DDS is adopted atop the swarm network as the off-chain storage to store raw UAV data. Therefore, the lightweight blockchain fabric may enhance the system robustness (e.g., availability and recoverability) for data-sharing applications compared with existing solutions that rely on centralized storage. Furthermore, the lightweight blockchain fabric stores encrypted sensitive information on the DDS while only recording references of raw data on the transparent distributed ledger. As a result, blockchain transactions only contain references of small size rather than large volumes of UAV data. Such a hybrid on-chain and off-chain data storage structure not only reduces communication and storage overheads but also ensures privacy preservation in the data-sharing process by exposing hash-style references as proofs.

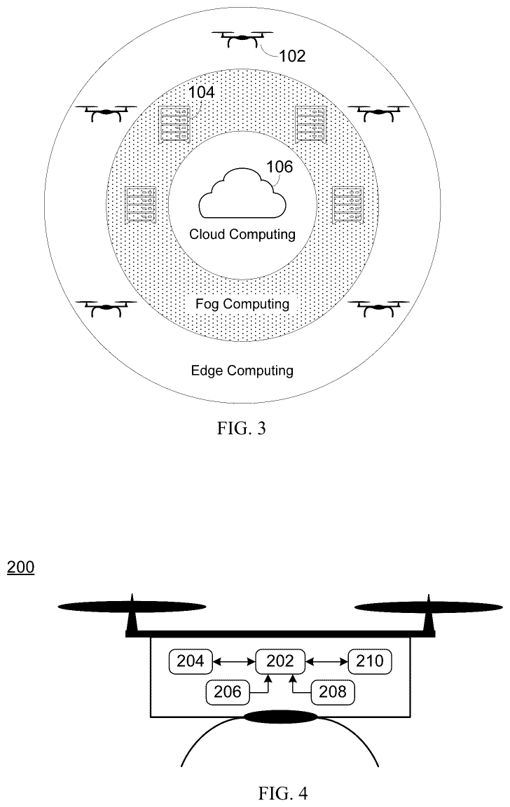

FIG. 3 shows a diagram of an exemplary UAM network environment according to the present disclosure. The exemplary UAM network may be similar to or the same as the UAM network 91 shown in FIG. 1. UAM networks are configured as decentralized and based on an edge-fog-cloud computing paradigm. UAM networks include an edge computing layer, a fog computing layer, and a cloud computing layer. The edge computing layer contains on-site edge devices and sensors, such as UAVs 102 (or onboard chips and sensors at UAVs 102). The on-site edge devices and sensors are responsible for enrolling and capturing raw mission data. The raw mission data may be digitized and converted into key features, such as aircraft identification and trajectories. While collected raw data is transferred to edge computing nodes for pre-processing and low-level feature extraction, only certain extracted features are transmitted to the fog computing layer for data aggregation and higher-level analytic services, such as route pattern recognition and anomalous event detection.

The fog computing layer contains fog nodes and dedicated databases, such as servers 104. The fog computing layer may be configured for intermediate-level feature contextualization and smart decision-making. For example, a surveillance system may use it to support intelligent analytic functions. Through analyzing extracted features, UAM navigation of mission planning may be constructed and saved to the operational database. In some cases, ML-based detection algorithms perform the aircraft authentication, either route verification or frame identification, based on a specified threshold of a scenario mission. Further, data-driven-based ML models may be trained. The trained ML models and archived operation data may be shared among inter-domain UAM networks and uploaded to the cloud servers for high-level information fusion and analysis tasks.

Further, the ML models may be used to create a detection module (e.g., the above-mentioned ML-based anomaly detection module of the lightweight blockchain fabric 90) that detects GPS spoofing attacks on UAVs at the fog node. In some embodiments, a fog node with a stored ML model may be integrated and configured on a UAV. In such cases, spoofing attacks may be detected by the UAV itself using the ML model, which may protect the UAV and the UAM networks from malicious attacks at the edge.

The cloud computing layer includes cloud infrastructure and dedicated databases, such as cloud 106 that contains servers and data storage. The cloud computing layer handles high-level tasks that are often computing extensive and big-data oriented, such as multi-airborne collaborative planning and decision-making reasoning. For example, based on a thorough analysis of shared avionics data among different airborne command and control (C2) nodes, comprehensive target identifiable information (TII) may be constructed by associating C2 individuals with historical information. In some UAM networks, the airborne C2 node may function as a control and reporting center.

FIG. 4 shows a diagram illustrating an exemplary UAV structure according to the present disclosure. As shown in FIG. 4, a UAV 200 may include a microcontroller unit (MCU) 202, a flight controller 204, a GPS 206, inertial measurement units (IMUs) 208, a communication module 210, an antenna (not shown), and batteries (not shown). The UAV 200 may also include propellers, motors, and other parts that are not annotated in the figure. The MCU 202 contains an onboard chip for data processing. The onboard chip is a processing chip and may have certain functions of a server in some cases. The flight controller 204 is responsible for the stable flight of the UAV 200, usually with predefined waypoint navigation. The GPS 206 is used for localization, and the IMUs 208 (e.g., an electronic compass, a gyroscope, a magnetometer, and/or an accelerometer) are utilized to measure flight dynamics such as pitch, yaw and roll angles. The communication module 210 is used to establish communication links between the UAV 200 and ground stations, ground users, or terrestrial base stations. The communication links include both command & control and payload communication links. In addition, software may be developed for an implementation of communications-related functions and functions for ground stations, such as mission planning, monitoring, data exchange, and control.

In some embodiments, a communication technology, such as WiFi, LTE, LoRa, or customized SDR, may be used at the UAV 200. Optionally, the UAV communication protocols may include MAVLink, UDP, or TCP/IP for data and control signal transmission. Usually, UAV communication contains two types of messages: state messages and command messages. The state messages are messages sent from a UAV to a ground station and contain information about the state of the UAV, such as its ID, location, velocity, and altitude. The command messages are messages sent from a ground station to the UAV for executing some actions by autopilot.

The GPS 206 is a critical component of the UAV 200. The absolute geolocation, altitude, longitude, latitude, and ground speed may be obtained from GPS data. Hence, any compromise of GPS data affects the flight control and mission completion of the UAV 200.

In some spoofing cases, a GPS-like waveform is transmitted to prevent a receiver of the UAV 200 from tracking authentic GPS satellite signals. The attacks may be applied to the UAV 200 through communication links such as the communication module 210. The most dangerous form of spoofing attack is one that attempts to deceive the receiver and manipulate the critical control messages of the UAV 200. Deceptive spoofing may involve transmitting a similar waveform, intending to trick the GPS receiver into believing that the false signals are actually good ones from GPS sources. A spoofer may interfere with the normal transmissions of the GPS satellites, by jamming the receiver for a short time and then broadcasting error signals at a higher power level to affect the receiver. In some cases, a spoofing attack may be launched without direct access to a UAV. For example, a spoofer may use another UAV that carries a jamming device capable of interfering with and modifying the onboard sensor measurements. In some GPS spoofing attacks, a forged GPS signal may be transmitted to a device to alter the perceived location. Consequently, the true location of the device may be disguised and the attacker may fool the device to navigate to a specific location, and then damage the device. Hence, it is desirable to detect GPS spoofing attacks on UAVs.

GPS signals are time series signals. Recent developments in deep learning techniques enable superior performance in time series modeling as well as anomaly detection for time series signals. For time series, recurrent neural networks (RNN) and some variants of convolutional neural networks (CNN) are popularly used to model the time series data patterns. A long short-term memory (LSTM) model is a type of RNN. An XceptionTime model is a variant of the CNN architecture. The LSTM and XceptionTime models are data-driven-based ML models, and both may be used for the detection of GPS spoofing attacks.

The LSTM model is designed for processing sequential signals by introducing the memory mechanism. It explores the dependency information in the sequences and learns the representations of the sequences that distinguish them without manually designing the features. In addition to the hidden state in ordinary RNN cells, the LSTM model introduces a cell state that acts as a “high-way” of the gradient by avoiding the interaction of nonlinearities with backpropagation. Moreover, the LSTM model employs multiple gates with nonlinearities to increase the expressive power of the network.

In traditional CNN architectures, one of the challenging tasks in designing CNN is selecting the right kernel size, which is crucial to extracting global or local information. In the XceptionTime model, instead of picking a filter with a specific size, multiple one-dimensional filters with different kernel sizes are adopted to extract short and long-time series' features simultaneously with the resulting feature maps being concatenated to construct the output features. Moreover, to mitigate the computational cost problems, as well as lessen the overfitting problems, the bottleneck layer is used as the first component within the XceptionTime model. In addition, by utilizing the techniques of depth-wise separable convolutions, adaptive average pooling, and non-linear normalization, the XceptionTime model achieves good classification performance in terms of time-series data.

In some cases, assume there are four representative types of GPS spoofing attacks that include an interim-biased type, an interim-random type, a continuous-biased type, and a continuous-random type. The terms “interim” and “continuous” indicate the duration of an attack. In an interim attack, the attack is initiated after several operational cycles and continues into certain next time cycles (e.g., 200-1000 time cycles). In a continuous attack, the attack is initiated at a certain operational cycle and continues to the end of a mission of a UAV. The terms “biased” and “random” indicate the mode of an attack. A biased attack manipulates sensor readings by adding or subtracting a constant value, while a random attack contaminates sensor readings with random noise. As illustrated above, GPS data includes data consisting of altitude, longitude, latitude, and ground speed. The parameters altitude, longitude, latitude, and ground speed may be considered as features of GPS data or GPS signals. Spoofing attacks on one specific feature may be referred to as single-feature spoofing attacks. Spoofing attacks on more than one feature may be referred to as multi-feature spoofing attacks.

Certain software emulation tools or software simulators may be used to generate spoofing attack scenarios for training the datasets used by the LSTM and XceptionTime models. The spoofing attack scenarios include single-feature and multi-feature attacks. The LSTM and XceptionTime models are trained in these scenarios, respectively.

In addition, the spoofing attack scenarios also include restricted attacks and generalized attacks. Compared to the restricted spoofing attacks, the generalized spoofing attacks are similar to the signal itself and thus stealthier and more difficult to detect. Assume for restricted single-feature spoofing attacks, a specific noise type is randomly added to the original signals. Take the altitude data as an example. The restricted spoofing attacks may have additive white Gaussian noise (AWGN) as the random type or a constant amplitude shift as the biased type. That is, the attacks may apply on time series data of the altitude feature with AWGN or a constant shift of amplitude, which are formulated as follows,

$${S}_{i}^{r} = \{ \begin{matrix}{S}_{i} , & i ∉ [ {d}_{k} , {l}_{k} ] \\ {S}_{i} + {N}_{i} + {c}_{k} , & {d}_{k} \leq i \leq {l}_{k} , 0 < k < K\end{matrix}$$

where Sᵢ∈S and Sᵢ^{r}∈S^{r} are the value of i-th data sample in the original and attacked altitude time series data with restricted assumptions, respectively. K is the number of intervals being attacked and k indicates the k-th interval. Nᵢ˜N (0, σ) is a zero-mean white noise, cₖ is a random number for shift bias in the k-th attack interval, dₖ is the start time index of the k-th attack interval when the attack is initiated and lₖ (0<dₖ<lₖ<Lₖ, Lₖ≤L) is the end time index when the attack ends. L is the total length of the time series data. dₖ and lₖ are random variables that determine the interval of the attack applied to the time series data corresponding to the interim attacks. If lₖ equals to L, the attack may be considered as a continuous attack. In total, the datasets may optionally contain 30000 data samples with the original data and attacked data half by half. A sliding window of 10 samples may be applied to make up the training samples (size of 10 by 1) and labels (1 for original data and 0 for attacked data) for the deep learning model. The dataset may be split as 70% for training, 20% for validation, and 10% for testing in some cases.

Both the LSTM and XceptionTime models may be trained and tested to verify the performance. The LSTM model leverages a linear layer and two layers with an out_feature of 64 and a dropout rate of 0.5. The loss function is cross-entropy. For the XceptionTime model, four series of modules with residual connections followed by Adaptive Average Pooling layers may be utilized. In the four fused XceptionTime modules, the numbers of depth-wise separable convolution filters may be, e.g., 16, 32, 64, and 128, respectively. The cross-entropy loss is considered.

Further, slow shifting situations (e.g., slow shifting patterns) match real-world spoofing patterns to a certain extent in some cases. As such, it is practical and useful to incorporate the slow shifting process when spoofing attacks are analyzed. For example, a slow shifting process may be represented by the following equation to evaluate attack types,

$${S}_{i}^{r} = \{ \begin{matrix}\begin{matrix}{S}_{i} , & i ∉ [ {d}_{k} , {l}_{k} ]\end{matrix} \\ {S}_{i} + {N}_{i} + ( i - {d}_{k} ) \frac{α \overline{S}}{{l}_{k} - {d}_{k} + 1} , {d}_{k} \leq i \leq {l}_{k} , 0 < k < K\end{matrix}$$

where α is the amplitude shift ratio, and S̅ is the mean of S. In some cases, the value of α may be 0.05 for the slow shifting process.

In some cases, a spoofing attack is a replay attack, i.e., the original signal is maliciously or fraudulently repeated or delayed. The replay attack is implemented by intercepting signals and re-transmitting them, thereby fooling the receiver for interference purposes.

As aforementioned, some attacks are generalized spoofing attacks that are similar to the signal itself and stealthier. Assume the generalized single-feature spoofing attacks have the following features: 1) the attacker observes the GPS signal for a certain amount of time; 2) the attacks are initialized randomly; 3) the duration of the interim attacks is randomly selected; 4) the shift bias is either positive or negative with a 50% probability; and 5) the observed GPS message is replayed with the above features to interfere with the original GPS signals. For example, the attack duration may be first determined by random integers defining the start and end index in the time series such as an interval with 1000 data samples. Within the attack duration of 1000 data samples, small parts of original data samples such as 200 data samples are corrupted by replaying various previously observed data samples that are randomly selected. For the bias, a random value is selected to determine the amount to shift the amplitude. The following equation formulates the generalized spoofing attacks.

$${S}_{i}^{r} = \{ \begin{matrix}\begin{matrix}{S}_{i} , & i ∉ [ {d}_{k} , {l}_{k} ]\end{matrix} \\ {S}_{i} + {S}_{{i}^{′}} + {c}_{k} , {d}_{k} \leq i \leq {l}_{k} , 0 < k < K\end{matrix}$$

where S_{i′} is the replayed Sᵢ from previously observed data. Both LSTM and XceptionTime models may be trained and tested with the datasets.

When a slow shifting process is added to the generalized spoofing attacks, it may be formulated as follows.

$${S}_{i}^{g} = \{ \begin{matrix}\begin{matrix}{S}_{i} , & i ∉ [ {d}_{k} , {l}_{k} ]\end{matrix} \\ {S}_{i} + {S}_{{i}^{′}} + ( i - {d}_{k} ) \frac{α \overline{S}}{{l}_{k} - {d}_{k} + 1} , {d}_{k} \leq i \leq {l}_{k} , 0 < k < K\end{matrix}$$

where α is the amplitude shift ratio, and S̅ is the mean of S. To be consistent with the restricted version, assume α=0.05 as well for emulating the slow shifting process in the generalized version. Resulting models are retrained and evaluated with the same architecture and parameter settings.

As aforementioned, in the multi-feature spoofing scenarios, the attacks involve two or more features (i.e., altitude, longitude, latitude, and ground speed). For restricted spoofing with multi-feature attacks, instead of the single-channel time series, four channels of time series are used. Each channel is arranged for detecting the restricted spoofing attacks on one feature with AWGN or random amplitude shifts. The channels may also be referred to as feature channels.

In generalized spoofing with multi-feature attacks, at least two features are compromised. Similar to the restricted spoofing attacks, the four channels are trained separately. Detection results from the four channels are then fused to a LSTM or XceptionTime model for overall generalized spoofing attack detection.

Spoofing attack detection services may be arranged among UAVs in the edge computing layer and servers in the fog computing layer using the LSTM or XceptionTime model. The spoofing attack detection services are machine learning based anomaly detection (MLAD) microservices built on the decentralized UAM networks. Each UAV is a client node or edge node (or edge device), while each server in the fog computing layer is a server node or fog node. After a UAV sends GPS signals to a server node, the server node may perform attack detection for the incoming signals by assigning the streaming signals into a trained attack detection model (e.g., the LSTM or XceptionTime model). The attack detection model calculates the probability of attacks for each feature and determines if attacks exist in the received GPS signals. In some embodiments, the probability of attacks may be obtained by calculating the probability of certain malicious patterns. In some cases, GPS signal data is first serialized using a Pickle package and further transmitted via socket communication to a server node. Optionally, the attack detection model (or ML-based anomaly detection module) may be deployed in the back-end to perform real-time detection by iteratively importing incoming signals through the detection process. The model may output the results and transfer them to the front-end. The results may include the probability of attacks in each feature channel.

In some embodiments, a server as a fog node in a fog computing layer may be installed at a ground station. UAVs and the server may be connected using the above-mentioned communication technology and UAV communication protocol.

In some embodiments, an onboard chip as a fog node in a fog computing layer may be installed at a UAV such as the UAV 200. The onboard chip may contain one or more processing chips. In some cases, the onboard chip or an MCU (e.g., the MCU 202) may function both as an edge node and as a fog node, sensing spoofing attacks by running a trained attack detection model. The trained attack detection model may be stored at the onboard chip, MCU, or a memory module connected to the onboard chip or MCU. GPS data received at the UAV may be transmitted to the onboard chip or MCU via a communication cable. The UAV with the capability of spoofing attack detection may be connected with other UAVs that do not have the detection capability, ascertaining GPS spoofing attacks not only for itself but also for the other UAVs. It may protect a group of UAVs when there is no support of attack detection from a fog node (e.g., a server) at a ground station. The UAVs may communicate with each other using the communication technology and UAV communication protocol mentioned above.

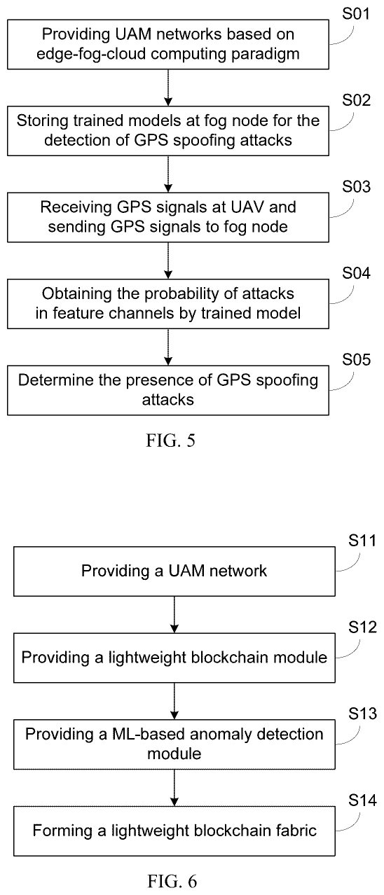

FIG. 5 shows a schematic flow chart to illustrate methods for detection of GPS spoofing attacks according to the present disclosure. At S01, decentralized UAM networks are provided based on an edge-fog-cloud computing paradigm. The UAM networks may create a network environment similar to that shown in FIG. 1 or FIG. 2. UAVs (or data processors at the UAVs) are the edge devices in the edge computing layer. The UAVs may have a structure similar to that shown in FIG. 4. Certain servers at ground stations or onboard chips on selected UAVs are the fog nodes in the fog computing layer.

At S02, data-driven-based attack detection models such as the LSTM model and XceptionTime model are trained by datasets. The datasets reflect GPS spoofing attack scenarios in certain feature channels, e.g., an altitude channel, a longitude channel, a latitude channel, and/or a ground speed channel. In some cases, the attacks may include an interim-biased type, an interim-random type, a continuous-biased type, and a continuous-random type, or any combination thereof. In some cases, the attacks may influence time series data with AWGN or a shift of amplitude. The shift of amplitude may be constant in some cases. The shift of amplitude may be changing along a timeline in some other cases. In some cases, the original signal may be taken and then repeated or delayed. Attack detection models may be trained with datasets in the feature channels, respectively. Then, the trained attack detection models are stored at the fog nodes, and the fog nodes may detect GPS spoofing attacks by running the model, respectively.

At S03, GPS signals are received at an edge device (e.g., a UAV). The edge device transmits the GPS signals to a fog node (e.g., a server). The fog node may be configured at a ground station. Optionally, the fog node may also be configured at a selected UAV.

At S04, attack detection for the GPS signals is performed by running the trained attack detection model at the fog node. In some cases, one of the LSTM and XceptionTime models is used to detect spoofing attacks. Alternatively, both the LSTM and XceptionTime models may be run to detect spoofing attacks in some other cases. The attack detection may be conducted in each feature channel, respectively. Optionally, in order to detect attacks, slow shifting spoofing patterns of spoofing signals are ascertained using the trained attack detection model. In some cases, the probability of certain malicious patterns is obtained by calculation to get the probability of attacks.

At S05, GPS spoofing attacks in the feature channels are determined based on the probability of the malicious patterns or the probability of attacks, respectively. Optionally, if the probability of attacks exceeds a given threshold level, it may indicate the GPS data is compromised and the presence of a GPS spoofing attack is detected.

Therefore, decentralized UAM networks may be formed based on an edge-fog-cloud computing paradigm. A trained attack detection model (e.g., the LSTM model or XceptionTime model) may be deployed at the fog nodes to sense forged GPS signals from UAVs. It not only protects the safety of the UAVs, but also shields the UAM networks from harmful attacks.

FIG. 6 shows an exemplary method for forming a lightweight blockchain fabric in accordance with the present disclosure. The lightweight blockchain fabric may be similar to or the same as that shown in FIG. 1. At S11, a UAM network (e.g., the UAM network shown in FIG. 1) is provided. The UAM network provides on-demand automated transportation services.

At S12, a lightweight blockchain module (e.g., the lightweight blockchain module 92 in FIG. 1) is provided. The lightweight blockchain module acts as a security and trust networking infrastructure to provide decentralized security and privacy-preserving guarantees for UAM data. The lightweight blockchain module includes a first sub-system and a second sub-system. The first sub-system includes a lightweight consensus protocol that relies on a randomly selected consensus committee to achieve a low latency when committing transactions on the distributed ledger. The second sub-system includes a hybrid on-chain and off-chain storage that improves efficiency and privacy-preservation.

UAV data and flight logs are stored securely and distributively without relying on any centralized server. The hybrid on-chain and off-chain storage includes DDS built on a swarm network. UAV data and flight logs are saved on the DDS and accessible or addressable by a swarm hash. Optionally, a transaction only includes the swarm hash as a reference pointing to corresponding raw data on the DDS.

At S13, a ML-based anomaly detection module is provided. The ML-based anomaly detection module is trained and includes one or more trained ML-based attack detection models. The one or more trained ML-based attack detection models include the above-illustrated LSTM model and/or XceptionTime model.

At S14, the lightweight blockchain fabric is formed. The lightweight blockchain fabric includes the UAM network, the lightweight blockchain module, and the ML-based anomaly detection module.

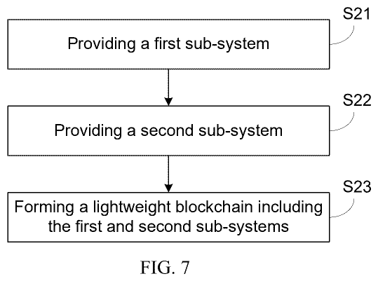

FIG. 7 shows an exemplary method for forming a lightweight blockchain in accordance with the present disclosure. The lightweight blockchain may have a structure and characteristics similar to or the same as that shown in FIG. 2. At S21, a first sub-system is provided. The first sub-system includes a lightweight consensus protocol that relies on a randomly selected consensus committee to achieve a low latency when committing transactions on the distributed ledger.

At S22, a second sub-system is provided. The second sub-system includes a hybrid on-chain and off-chain storage that improves efficiency and privacy-preservation. The hybrid on-chain and off-chain storage includes DDS built on a swarm network. The DDS is arranged to save UAV data and flight logs. The UAV data and flight logs are accessible or addressable by a swarm hash. In some cases, a transaction only includes the swarm hash as a reference pointing to corresponding raw data on the DDS.

At S23, the lightweight blockchain is formed that includes the first and second sub-systems. A structure of the lightweight blockchain includes confirmed blocks and finalized blocks. Each of the confirmed blocks and finalized blocks uses a pre_hash to point to a corresponding parent block and extend a chain. A consensus mechanism runs on a predetermined small number of validators.

As illustrated above, the lightweight blockchain fabric is configured for data assurance and resilience-oriented UAM networks. The lightweight blockchain fabric is tailored for small-scale permissioned UAM networks, in which a lightweight blockchain acts as a lightweight distributed ledger for security guarantees. As such, participants are enabled to authenticate UAVs and verify the genuineness of data that are sent to/from UAVs without relying on a third-party agency. In addition, a hybrid on-chain and off-chain storage is adopted that not only improves performance (e.g., latency and throughput) but also ensures privacy preservation for sensitive information in UAM networks.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A method for detecting a spoofing attack on an unmanned aerial vehicle (UAV), comprising:
receiving signals from the UAV, the UAV being an edge device of a decentralized network;
transmitting the signals to a fog node of the decentralized network; and
detecting the spoofing attack by detecting slow shifting patterns and running a trained attack detection model at the fog node for the signals, the decentralized network based on an edge-fog-cloud computing paradigm.

2. The method according to claim 1, wherein the trained attack detection model includes a long short-term memory (LSTM) model and/or an XceptionTime model.

3. The method according to claim 1, wherein the fog node is at the UAV or another UAV.

4. The method according to claim 1, wherein the fog node is at a ground station.

5. The method according to claim 1, wherein the signals are from a global positioning system (GPS) of the UAV.

6. The method according to claim 5, further comprising:
detecting the spoofing attack in a feature channel for the signals, the feature channel including an altitude channel, a longitude channel, a latitude channel, or a ground speed channel.

7. The method according to claim 1, further comprising:
calculating a probability of a given pattern to detect the spoofing attack.

8. A method for forming a lightweight blockchain fabric, comprising:
providing an urban air mobility (UAM) network, wherein the UAM network provides an on-demand automated transportation service;
providing a lightweight blockchain module, wherein the lightweight blockchain module includes a first sub-system and a second sub-system, the first sub-system includes a lightweight consensus protocol that relies on a randomly selected consensus committee to achieve a low latency when committing transactions on a distributed ledger, and the second sub-system includes a hybrid on-chain and off-chain storage that improves efficiency and privacy-preservation;
providing a machine learning (ML)-based anomaly detection module, wherein the ML-based anomaly detection module includes one or more trained ML-based attack detection models; and
forming the lightweight blockchain fabric that includes the UAM network, the lightweight blockchain module, and the ML-based anomaly detection module.

9. The method according to claim 8, wherein the lightweight blockchain module acts as a security and trust networking infrastructure to provide decentralized security and privacy-preserving guarantees for UAM data.

10. The method according to claim 8, wherein unmanned aerial vehicle (UAV) data and flight logs are stored securely and distributively without relying on any centralized server.

11. The method according to claim 8, wherein the hybrid on-chain and off-chain storage includes distributed data storage (DDS) built on a swarm network.

12. The method according to claim 11, wherein unmanned aerial vehicle (UAV) data and flight logs are saved on the DDS and accessible by a swarm hash.

13. The method according to claim 12, wherein a transaction only includes the swarm hash as a reference pointing to corresponding raw data on the DDS.

14. The method according to claim 8, wherein the one or more trained ML-based attack detection models include a long short-term memory (LSTM) model and/or an XceptionTime model.

15. A method for forming a lightweight blockchain, comprising:
providing a first sub-system, wherein the first sub-system includes a lightweight consensus protocol that relies on a randomly selected consensus committee to achieve a low latency when committing transactions on a distributed ledger;
providing a second sub-system, wherein the second sub-system includes a hybrid on-chain and off-chain storage that improves efficiency and privacy-preservation, the hybrid on-chain and off-chain storage includes distributed data storage (DDS) built on a swarm network, the DDS is arranged to save unmanned aerial vehicle (UAV) data and flight logs, and the UAV data and flight logs are accessible by a swarm hash; and
forming the lightweight blockchain that includes the first and second sub-systems.

16. The method according to claim 15, wherein a transaction only includes the swarm hash as a reference pointing to corresponding raw data on the DDS.

17. The method according to claim 15, wherein a consensus mechanism runs on a predetermined small number of validators.

18. The method according to claim 15, wherein a structure of the lightweight blockchain includes a plurality of confirmed blocks and a plurality of finalized blocks and each of the plurality of confirmed blocks and the plurality of finalized blocks uses a pre_hash to point to a corresponding parent block and extend a chain.

19. The method according to claim 15, wherein a chain height follows an increasing sequence of a plurality of finalized blocks.

20. The method according to claim 15, wherein a workflow of the lightweight blockchain includes an initialization step, a committee selection step, a block proposal step, a chain finality step, and a committee change step.
